(19) United States
(12) Patent Application Publication
(10) Pub. No.: US 2014/0088993 A1
(43) Pub. Date: Mar. 27, 2014

(54) GRAPH GENERATION DEVICE, GRAPH GENERATION METHOD AND GRAPH GENERATION PROGRAM

(71) Applicant: FUJIFILM Corporation, Tokyo (JP)

(72) Inventors: Meiji ITOH, Ashigarakami-gun (JP); Yasunori Ohta, Ashigarakami-gun (JP); Akira Oosawa, Adhigarakami-gun (JP); Shoji Kanada, Ashigarakami-gun (JP)

(73) Assignee: FUJIFILM Corporation, Tokyo (JP)

(21) Appl. No.: 14/033,230

(22) Filed: Sep. 20, 2013

(30) Foreign Application Priority Data
Sep. 27, 2012 (JP) 2012-213637

(51) Int. Cl. G06F 19/00

(52) U.S. Cl. CPC G06F 19/366
USPC 705/2

(57) ABSTRACT

Test intervals respectively corresponding to a plurality of medical tests for diagnosis or treatment are obtained, and a period to be displayed on a time series graph showing test results of the medical tests is determined such that the period to be displayed is not shorter than the longest test interval of the obtained test intervals. Then, the time series graph is generated based on the determined period to be displayed and test results of the medical tests performed on a given subject.

### BACKGROUND OF THE INVENTION

1. Field of the Invention

The present invention relates to a graph generation device and a method for operating the graph generation device, as well as a graph generation program for generating a time series graph showing test results of a plurality of medical tests.

2. Description of the Related Art

In recent years, in the medical field, results of a plurality of medical tests performed on the patient are displayed during a medical examination and are used as reference information to identify the disease name, determine a therapeutic strategy, etc.

There are various types of medical tests performed on patients.

In actual medical practice, when the patient is suspected to have a specific disease, diagnosis or treatment is performed with referencing test results of a plurality of medical tests that are regarded important for the diagnosis of the specific disease. With conventional display devices for displaying test results, it is often the case that only results of the medical tests performed on the patient during the last medical examination are displayed on the screen. In order to check transitions of the test results, the doctor, or the like, needs to search for past test results of each desired medical test and compare the test results with one another to understand the transitions of the test results of the desired medical test. In order to facilitate understanding of the transitions of results of a plurality of medical tests, Japanese Unexamined Patent Publication Nos. 2002-203199, 2 (1990)-011129, 2001-118008 and 2001-133293 (hereinafter, Patent Documents 1 to 4, respectively), for example, disclose techniques for integrating and displaying results of different types of medical tests for a given period of the past on a time series graph.

### SUMMARY OF THE INVENTION

However, in order to generate a time series graph showing results of a plurality of medical tests according to the techniques disclosed in Patent Documents 1 to 4, the user needs to set an appropriate period to be displayed on the graph. Further, since intervals between past test dates of the tests may vary depending on various factors, a given period to be displayed may not always be an appropriate period for the displayed data.

In view of the above-described circumstances, the present invention is directed to providing a graph generation device and a method for operating the graph generation device, as well as a graph generation program for generating a graph showing transitions of test results of a plurality of medical tests, which facilitates setting an appropriate period to be displayed so that the user can understand transitions of the test results of the medical tests shown on the graph.

An aspect of the graph generation device according to the invention is a graph generation device including: a test interval obtaining unit that obtains a plurality of test intervals respectively corresponding to a plurality of medical tests for diagnosis or treatment; a period to be displayed determining unit that determines a period to be displayed on a time series graph showing test results of the medical tests, wherein the period to be displayed is not shorter than the longest test interval of the obtained test intervals; and a graph generation unit that generates the time series graph based on the determined period to be displayed and test results of the medical tests performed on a given subject.

An aspect of the graph generation method according to the invention is a graph generation method for use with a graph generation device, the method including: a test interval obtaining step of obtaining a plurality of test intervals respectively corresponding to a plurality of medical tests for diagnosis or treatment; a period to be displayed determining step of determining a period to be displayed on a time series graph showing test results of the medical tests, wherein the period to be displayed is not shorter than the longest test interval of the obtained test intervals; and a graph generation step of generating the time series graph based on the determined period to be displayed and test results of the medical tests performed on a given subject.

A graph generation program according to the invention causes a computer to execute the above-described method.

The “plurality of medical tests for diagnosis or treatment” herein refers to medical tests performed for the purpose of diagnosis or treatment of patients, and includes any medical tests that can be shown on a time series graph based on test dates (and times) and values of test results of the medical tests.

As the first aspect of the graph generation device of the invention, the test interval obtaining unit may obtain, for each of the medical tests, past test intervals between past test dates of the medical test performed on a plurality of subjects of the past, calculate a frequency distribution of the past test intervals of the medical test based on the obtained past test intervals of the medical test, and determine and obtain the test interval of the medical test based on the calculated frequency distribution.

The “given subject” herein may or may not be included in the “plurality of subjects of the past”. The “plurality of subjects of the past” may have the same disease as the disease of the given subject.

In the first aspect of the graph generation device of the invention, the test interval obtaining unit may use any method to determine the test interval, as long as the test interval obtaining unit obtains, for each of the plurality of medical tests, past test intervals between past test dates of the medical test performed on a plurality of subjects of the past, calculates a frequency distribution of the past test intervals of the medical test based on the obtained past test intervals of the medical test, and determines, based on the calculated frequency distribution, the test interval of the medical test such that a class that accounts for the main proportion of the frequency distribution is included. For example, the test interval obtaining unit may calculate a cumulative frequency corresponding to each past test interval based on the frequency distribution, and determine the past test interval corresponding to the calculated cumulative frequency that reaches or exceeds a predetermined threshold value to use it as the test interval of the medical test. Alternatively, the test interval obtaining unit may calculate a normal distribution of the frequencies of the past test intervals based on the frequency distribution of the frequencies of the past test intervals, calculate a mean value and a variance of the past test intervals, and determine the test interval of the medical test such that the test interval is not less than a sum of the mean value and the variance of the past test intervals.

In the first aspect of the graph generation device of the invention, the test interval obtaining unit may obtain, for each of the medical tests, only past test intervals of the medical test performed on the plurality of subjects of the past during their periods of hospital visits, and the graph generation unit may generate the time series graph showing the test results of the given subject during a period of hospital visits of the given subject.

In the first aspect of the graph generation device of the invention, the display interval determining unit may determine the longest test interval within a predetermined upper limit. The “predetermined upper limit” herein may, for example, be two years, or may be one year.

As the second aspect of the graph generation device of the invention, the test interval obtaining unit may obtain an upper limit of the period to be displayed on the time series graph, obtain, for each of the medical tests performed on the given subject, a predetermined number of test intervals immediately before the upper limit of the period to be displayed on the time series graph, and obtain the obtained predetermined number of test intervals to use them as the test interval of the medical test.

The “upper limit of the period to be displayed” herein refers to the end of the period to be displayed, such as the year, the month, the day, the time and date, etc., of the end of the period to be displayed. The “predetermined number of test intervals immediately before the upper limit of the period to be displayed” herein refers to a predetermined number of test intervals in time series before the end of the period to be displayed. The “predetermined number of test intervals” may be any number of test intervals equal to or greater than one.

In the first and second aspects of the graph generation device of the invention, the graph generation unit may generate the time series graph based only on given types of test results selected from test results of the medical tests depending on the disease of the given subject.

According to the present invention, test intervals of a plurality of medical tests for diagnosis or treatment are obtained, and the period to be displayed on a time series graph showing test results of the plurality of medical tests performed on a given subject is determined such that the period to be displayed is not shorter than the longest test interval of the obtained test intervals. Then, the time series graph is generated based on the determined period to be displayed. This facilitates setting an appropriate period to be displayed to generate a graph that shows transitions of the test results of the plurality of medical tests in a manner preferably understandable by the user.

### BRIEF DESCRIPTION OF THE DRAWINGS

FIG. 1 is a diagram illustrating the schematic configuration of a medical information system to which a graph generation device according to first and second embodiments of the present invention is applied,

FIG. 2 is a flow chart illustrating the flow of graph generation in the first embodiment of the invention,

FIG. 3 is a diagram for explaining a period obtaining process in the first embodiment of the invention (an example case of white blood cell count),

FIG. 4 is a diagram for explaining the period obtaining process in the first embodiment of the invention (an example case of CEA),

FIG. 5 is a diagram illustrating an example of a graph generated in the first and second embodiments of the invention, and

FIG. 6 is a flow chart illustrating the flow of graph generation in the second embodiment of the invention.

### DESCRIPTION OF THE PREFERRED EMBODIMENTS

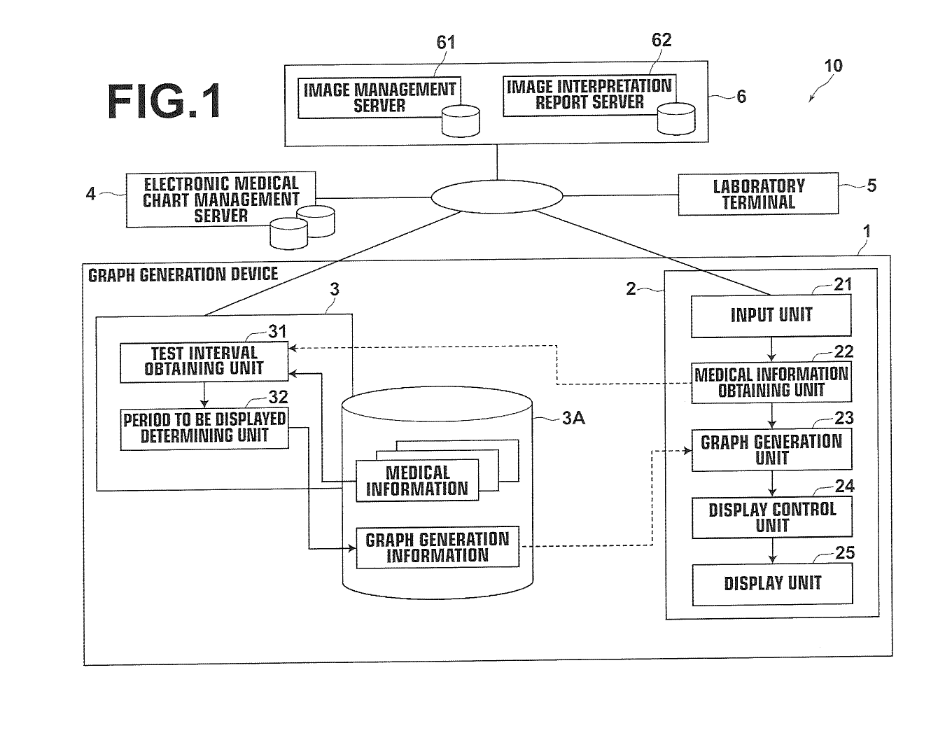

Hereinafter, embodiments of a graph generation device of the present invention will be described based on FIG. 1. FIG. 1 is a diagram illustrating the schematic configuration of a medical information system to which the graph generation device according to first and second embodiments of the invention is applied, and is a function block diagram of the graph generation device in one embodiment of the invention.

As shown in FIG. 1, a medical information system 10 includes a medical information management server 3, an electronic medical chart management server 4, a diagnosis and treatment department terminal 2, a laboratory terminal 5 and an imaging diagnosis system 6, which are connected via a network so as to be able to communicate with one another.

The electronic medical chart management server 4 is a computer including an electronic medical chart database storing electronic medical charts, and has installed therein, besides an operating system and database management software, software for performing search of medical information, such as images associated with each electronic medical chart, test results, etc., and sending or receiving search results in response to a request from the diagnosis and treatment department terminal 2, or the like. The electronic medical chart management server 4 is connected to the medical information management server 3, the diagnosis and treatment department terminal 2, the laboratory terminal 5, the imaging diagnosis system 6, etc., via the network so as to be able to obtain the medical information associated with each electronic medical chart.

The laboratory terminal 5 is a computer that is placed at a laboratory apart from each diagnosis and treatment department, and is used to input information of a test result of a medical test performed at the laboratory according to an order for medical test inputted from each diagnosis and treatment department terminal 2. The laboratory terminal 5 has installed therein software for viewing an order for medical test and inputting a test result, besides the basic software, such as an operation system. The information of the test result of a medical test performed at each laboratory is inputted with being associated with the order for medical test, the patient ID, etc., via the laboratory terminal 5. The medical information management server 3, which will be described later, functions as a management server for the information of test results inputted from the laboratory terminal 5, and the inputted information of test results is stored in a medical information management database 3A.

The imaging diagnosis system 6 is a known computer system. The imaging diagnosis system 6 herein includes: an imaging diagnosis medical workstation (not shown); a modality (not shown), such as a CT or MRI apparatus; an image management server 61, which includes an image database for storing image data obtained by imaging with the modality, such as a CT or MRI apparatus; and an image interpretation report server 62, which includes an image interpretation report database for storing image interpretation reports containing results of image interpretation of the images obtained by the imaging. These components of the imaging diagnosis system 6 are connected via the network so as to be able to communicate with one another. The imaging diagnosis medical workstation has various types of image analysis software installed therein and is adapted to be able to perform various types of image analysis processes depending on the purpose and the subject of diagnosis.

The graph generation device 1 of this embodiment is formed by the medical information management server 3 and the diagnosis and treatment department terminal 2, which are connected via the network. The computers serving as the medical information management server 3 and the diagnosis and treatment department terminal 2 are controlled by a program that is installed from a recording medium, such as a CD-ROM, to function as the graph generation device 1 of this embodiment. Alternatively, the program may be downloaded from a storage device of a server connected via a network, such as the Internet, before being installed.

The medical information management server 3 is a computer including the medical information management database 3A. The medical information management server 3 is connected to the electronic medical chart management server 4, the laboratory terminal 5, the image management server 61 and the image interpretation report server 62 via the network. The medical information management server 3 searches for and obtains medical information of each patient, such as an electronic medical chart, results of various medical tests, image data and image interpretation reports, based on the patient ID of the patient from the servers, etc., connected thereto, and stores the obtained medical information being associated with each patient ID. In a case where one patient has two or more diseases, the medical information associated with the patient ID of the patient is stored for each disease. It should be noted that the medical information management server 3 updates the medical information being managed therein at a fixed time every day.

The medical information management server 3 also functions as a management server for managing graph generation information, which defines, for each disease, the necessary information to generate a time series graph. Each graph generation information is stored in the medical information management database 3A. The graph generation information includes settings of the necessary information to generate a graph, such as the disease name, the names of given medical tests shown on the graph, the range of the vertical axis of the graph, the range of the horizontal axis of the graph (a period to be displayed), colors, line types, fonts, sizes, etc. As the given medical tests shown on a graph, a plurality of medical tests that are regarded important for the diagnosis of each disease are selected and set in advance by the user depending on the disease. Further, the numerical range along the vertical axis of the graph is set for each medical test included in the given medical tests depending on the test values thereof. The period to be displayed included in the graph generation information is determined by a period to be displayed determining unit 32, which will be described later. The other values included in the graph generation information are set in advance.

The medical information management server 3 has installed therein, besides an operating system and database management software, parts defining a test interval obtaining process and a period to be displayed determining process of a graph generation program according to this embodiment. When this program is executed, the medical information management server 3 functions as a test interval obtaining unit 31, which obtains a plurality of test intervals respectively corresponding to a plurality of medical tests for diagnosis or medical care, and as a period to be displayed determining unit 32, which determines the period to be displayed on a time series graph showing test results of the medical tests such that the period to be displayed is not shorter than the longest test interval of the obtained test intervals.

The diagnosis and treatment department terminal 2 is a computer used by a doctor, etc., of the diagnosis and treatment department to view clinical information of a patient, to input an order for medical test, etc. The diagnosis and treatment department terminal 2 includes a display unit 25, which is a typical display, and an input unit 21 formed by a keyboard and a mouse. The diagnosis and treatment department terminal 2 is also used to display a graph showing transitions of test results of medical tests performed at each diagnosis and treatment department, the medical information, such as a generated electronic medical chart, etc., to be referenced by the user, and has installed therein application software for displaying the medical information, such as a generated electronic medical chart, besides the basic software, such as an operation system.

Further, the diagnosis and treatment department terminal 2 has installed therein parts defining a medical information obtaining process, a graph generation process and a display control process of the graph generation program according to this embodiment. When this graph generation program is executed, the diagnosis and treatment department terminal 2 functions as a medical information obtaining unit 22, which obtains medical information, such as test results, of the patient to be diagnosed (the subject of the given medical tests), as a graph generation unit 23, which generates a time series graph based on the set period to be displayed and the test results of the medical tests performed on the patient to be diagnosed, and as a display control unit 24, which obtains the generated time series graph and displays it on the display unit 25.

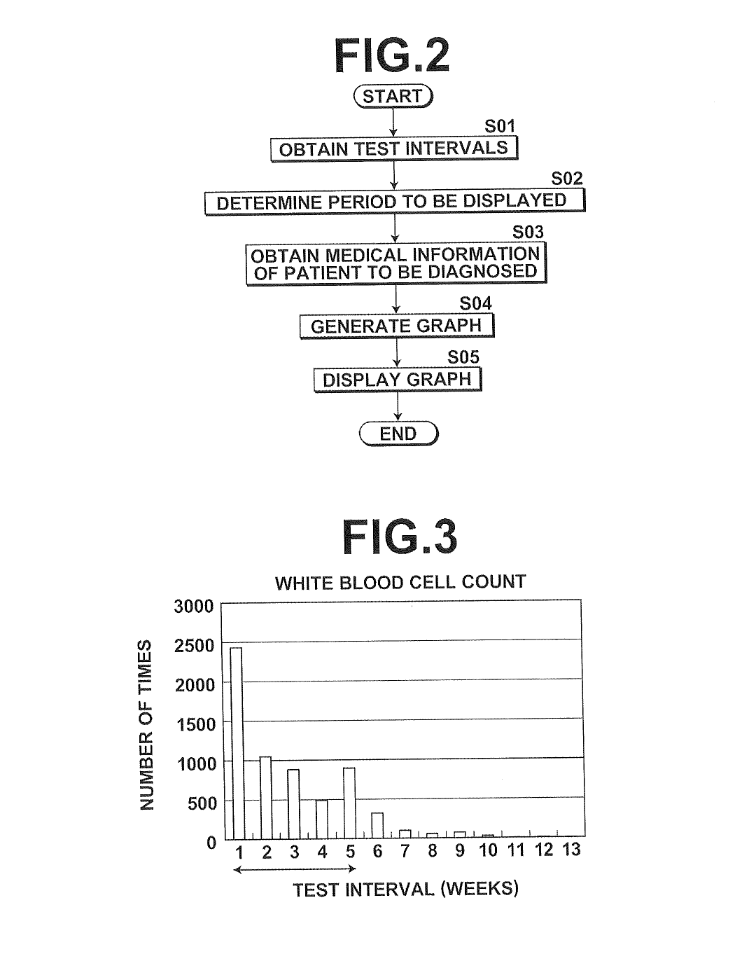

FIG. 2 is a flow chart illustrating the flow of operations performed by the graph generation device. Now, the flow of operations performed by the graph generation device is described according to FIG. 2.

First, the test interval obtaining unit 31 extracts and obtains only medical information relating to a given disease from pieces of medical information stored in the medical information management database 3A. Then, for each medical information, the test interval obtaining unit 31 obtains past test intervals between past test dates of each medical test Ti (1<i≦n, where n is the number of types of the medical tests). Based on the obtained past test intervals of the medical test Ti, the test interval obtaining unit 31 calculates a frequency distribution of the past test intervals of the medical test Ti, and determines a test interval Pi of the medical test Ti based on the calculated frequency distribution (ST01). The test interval obtaining unit 31 obtains the test interval Pi for each of the n medical tests Ti (1<i≦n, where n is the number of types of the medical tests).

Assuming that a frequency corresponding to each past test interval Pij (0≦j≦m, where m is the number of past test intervals) in the frequency distribution of each medical test Ti is Fij (1≦j≦m, where m is the number of past test intervals), the test interval obtaining unit 31 in the first embodiment calculates a cumulative frequency Sij (=F1+ . . . +Fj) of the frequencies Fij (1≦j≦m, where m is the number of past test intervals) for each past test interval Pij (0≦j≦m, where m is the number of past test intervals) based on the frequency distribution of the medical test Ti. Then, the test interval obtaining unit 31 determines the past test interval Pij corresponding to the cumulative frequency Sij that first reaches or exceeds a predetermined threshold value (0.8) to use it as the test interval Pi of the medical test Ti.

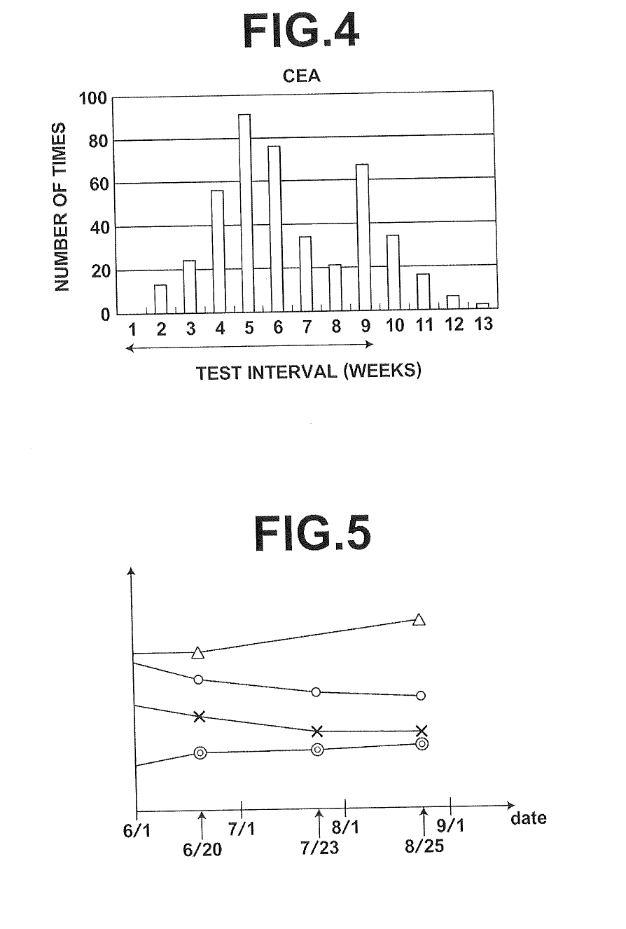

Now, using examples shown in Tables 1 and 2, a specific method for calculating the test interval of each of medical tests with respect to CEA, which is a tumor marker, and with respect to white blood cell count is described. Table 1 shows the number of times when each test interval of the white blood cell count is extracted, the frequency of each test interval, and the cumulative frequency corresponding to each test interval. FIG. 3 shows a frequency distribution histogram corresponding to Table 1. Table 2 shows the number of times when each test interval of the CEA serving as a tumor marker is extracted, the frequency of each test interval, and the cumulative frequency corresponding to each test interval. FIG. 4 shows a frequency distribution histogram corresponding to Table 2.

In the example case of the white blood cell count shown in Table 1, the cumulative frequency corresponding to the test interval of five weeks first reaches or exceeds 0.8, and therefore the test interval of the white blood cell count is determined to be five weeks. In the example case of the CEA shown in Table 2, the cumulative frequency corresponding to the test interval of nine weeks first reaches or exceeds 0.8, and therefore the test interval of the CEA is determined to be nine weeks. In each of the examples shown in Tables 1 and 2, the determined test interval is indicated by the thicker frame.

TABLE 1
<White Blood Cell Count>

| | The | | |
|---|---|---|---|
| Test interval | number of | | Cumulative |
| (weeks) | times | Frequency | frequency |
| 1 | 2430 | 0.385 | 0.385 |
| 2 | 1045 | 0.166 | 0.550 |
| 3 | 881 | 0.140 | 0.690 |
| 4 | 485 | 0.077 | 0.767 |
| 5 | 894 | 0.142 | 0.908 |
| 6 | 320 | 0.051 | 0.959 |
| 7 | 97 | 0.015 | 0.974 |
| 8 | 56 | 0.009 | 0.983 |
| 9 | 69 | 0.011 | 0.994 |
| 10 | 23 | 0.004 | 0.998 |
| 11 | 4 | 0.001 | 0.998 |
| 12 | 8 | 0.001 | 1.000 |
| 13 | 2 | 0.000 | 1.000 |
| Total | 6314 | | |

TABLE 2
<CEA>

| | The | | |
|---|---|---|---|
| Test interval | number of | | Cumulative |
| (weeks) | times | Frequency | frequency |
| 1 | 0 | 0.000 | 0.000 |
| 2 | 13 | 0.030 | 0.030 |
| 3 | 24 | 0.055 | 0.084 |
| 4 | 56 | 0.127 | 0.211 |
| 5 | 91 | 0.207 | 0.418 |
| 6 | 76 | 0.173 | 0.591 |
| 7 | 34 | 0.077 | 0.668 |
| 8 | 21 | 0.048 | 0.716 |
| 9 | 67 | 0.152 | 0.868 |
| 10 | 34 | 0.077 | 0.945 |
| 11 | 16 | 0.036 | 0.982 |
| 12 | 6 | 0.014 | 0.995 |
| 13 | 2 | 0.005 | 1.000 |
| Total | 440 | | |

In the case where the test interval Pi of each medical test Ti (1<i≦n, where n is the number of types of the medical tests) is determined in the manner as described above, at least two test results of each medical test Ti are included in the test interval Pi of the medical test Ti at a probability of at least the threshold value (a probability of 80% or more in these examples) depending on the cumulative frequency, as shown in FIG. 3 or 4. Therefore, by determining the period to be displayed such that the period to be displayed is not shorter than the longest test interval of the test intervals of the medical tests and generating a time series graph based on the determined period to be displayed, the time series graph contains two or more test results of each of the plurality of medical tests at a probability of at least the threshold value. Referencing the thus generated graph preferably allows the user to understand transitions of the test results of the plurality of medical tests.

It should be noted that any of various methods for determining the test interval may be applied to the test interval obtaining unit 31, as long as the test interval obtaining unit 31 obtains pieces of medical information stored in the medical information management database 3A, obtains, for each medical information, past test intervals between past test dates of each medical test Ti (1<i≦n, where n is the number of types of the medical tests), calculates the frequency distribution of the past test intervals of each medical test Ti based on the obtained past test intervals of the medical test Ti, and determines, based on the calculated frequency distribution, the test interval Pi of each medical test Ti such that a class that accounts for the main proportion of the frequency distribution is included.

For example, based on the frequency distribution, the test interval obtaining unit 31 may determine the test interval Pi with setting the threshold value condition such that two or more test results of each medical test Ti are included at a probability of 50% or more, or may optionally determine the test interval Pi with setting the threshold value condition such that two or more test results of each medical test Ti are included at a probability of 60% or more. In this embodiment, the test interval Pi is determined with setting the threshold value condition such that two or more test results of each medical test Ti are included at a probability of 80% or more, and therefore the period to be displayed can very preferably be determined such that two or more test results of each medical test are included, and the generated graph can more preferably show transitions of the test results of the plurality of medical tests.

As another method for obtaining the test interval based on the frequency distribution, the test interval obtaining unit 31 may calculate, for example, a normal distribution of the frequencies of the past test intervals Pij based on the frequency distribution of the frequencies of each medical test Ti, and may determine, based on a mean value and a variance of the past test intervals of the calculated normal distribution, the test interval Pi such that the test interval Pi is not less than a sum of the mean value and the variance of the past test intervals. Still alternatively, the test interval obtaining unit 31 may identify a test interval Pip that corresponds to the peak of the frequencies of each medical test Ti and determine the test interval Pi such that the test interval Pi is not shorter than the test interval Pip.

Then, the period to be displayed determining unit 32 determines, based on the plurality of test intervals respectively corresponding to the plurality of medical tests obtained by the test interval obtaining unit 31, the period to be displayed on the time series graph such that the period to be displayed is not shorter than longest test interval Pmax of the test intervals of the medical tests (S02).

In this example, the period to be displayed determining unit 32 determines the period to be displayed depending on the determined test interval Pmax according to Table 3. Table 3 contains preset periods to be displayed in increments of week, month, etc., which are set to be near to the test interval Pmax and longer than the test interval Pmax based on the test interval Pmax. By determining the period to be displayed in an appropriate unit (in increments of week, month, etc.) which is near to the test interval Pmax based on the test interval Pmax, as shown in Table 3, the user can more easily understand the period displayed on the graph. In the examples shown in FIGS. 3 and 4, the test interval of the medical test of “white blood cell count” is five weeks, and the test interval of the medical test of “CEA” is nine weeks. Therefore, the test interval Pmax is nine weeks (63 days), and the period to be displayed is determined to be three months according to Table 3.

TABLE 3

| Test interval Pmax | Period |
|---|---|
| (days) | to be displayed |
| 0 to 6 | 1 week |
| 7 to 31 | 1 month |
| 32 to 92 | 3 months |
| 93 to 182 | 6 months |
| 183 or more | 1 year |

Further, the period to be displayed determining unit 32 determines the longest test interval that is within a predetermined upper limit (within 1 year) of the test intervals respectively corresponding to the plurality of medical tests. To this end, the period to be displayed determining unit 32 in this embodiment determines the longest test interval of the obtained test intervals other than the test intervals longer than 1 year. Since there may be a case where the result of the medical test is improved and it is no longer necessary to perform the medical test as often as before, resulting in a long test interval, a more appropriate period to be displayed can be determined by calculating the longest test interval Pmax within a predetermined period. It should be noted that the present invention is not limited to this embodiment, and the period to be displayed determining unit 32 may determine the longest test interval of the test intervals respectively corresponding to the plurality of medical tests without setting an upper limit.

Then, the period to be displayed determining unit 32 obtains the graph generation information corresponding to the given disease, and sets the determined period to be displayed as the period to be displayed of the graph generation information. Although the test interval obtaining process and the period to be displayed determining process performed in S01 to S02 in the above-described embodiment are set to be regularly performed at a predetermined time every day for each of all the diseases, the test interval obtaining process and the period to be displayed determining process can be performed at any timing in response to a request from each terminal.

Then, when a doctor of the diagnosis and treatment department inputs the patient ID of the patient to be diagnosed via the input unit 21 for the purpose of checking the medical information of the patient to be diagnosed on the diagnosis and treatment department terminal 2, the medical information obtaining unit 22 receives the input by the doctor and obtains the patient ID, and then obtains the corresponding medical information from the medical information management server 3 based on the patient ID and stores the obtained medical information in the memory of the diagnosis and treatment department terminal 2 (S03). Further, the medical information obtaining unit 22 obtains the disease name of the disease of the patient (or the name of a suspected disease of the patient) from the electronic medical chart contained in the obtained medical information.

Subsequently, the graph generation unit 23 obtains the graph generation information corresponding to the disease of the patient from the medical information management server 3, and extracts, based on the obtained graph generation information, test results of the given medical tests set in the graph generation information from the obtained medical information of the patient to be diagnosed. Then, the graph generation unit 23 generates a graph showing the extracted test results of the given medical tests according to the obtained graph generation information (S04). It should be noted that the graph generation unit 23 receives an input of an upper limit of the period to be displayed on the graph and generates the graph such that the inputted date is the last day of the period displayed on the graph. If no upper limit of the period to be displayed on the graph is inputted, the graph is generated such that the date on which the graph generation process is performed is the upper limit of the period displayed on the graph.

Then, the display control unit 24 displays the time series graph generated by the graph generation unit 23 on the display unit 25, and the process ends (S05). FIG. 5 shows an example of the displayed time series graph. In this example, four types of medical tests performed on the patient to be diagnosed are set as the given medical tests (in FIG. 5, test results of CAE are indicated by triangles, test results of red blood cells are indicated by circles, test results of hemoglobin concentration are indicated by “X”s, and test results of white blood cells are indicated by double circles.) The date on which the graph is generated is September 1st, and therefore the upper limit of the period displayed on the graph is September 1st.

It should be noted that the test interval obtaining process and the period to be displayed determining process shown in S01 to S02 may be performed at any timing as long as these processes are performed at least once prior to the graph generation process shown in S04. For example, the test interval obtaining process and the period to be displayed determining process shown in S01 to S02 may be performed after or in parallel with the medical information obtaining process shown in S03, or the test interval obtaining process and the period to be displayed determining process may be performed first and the medical information obtaining process in S03 and the following operations may be performed after an arbitrary time.

According to the above-described embodiment, a plurality of test intervals respectively corresponding to a plurality of medical tests for diagnosis or treatment are obtained, and a period to be displayed on a time series graph showing test results of the medical tests is determined such that the period to be displayed is not shorter than the longest test interval of the obtained test intervals. Then, the time series graph is generated based on the determined period to be displayed and the test results of the plurality of medical tests performed on the given subject. This facilitates setting an appropriate period to be displayed to generate a graph that shows transitions of the test results of the plurality of medical tests in a manner preferably understandable by the user. Further, no extra work by the user, such as searching for test intervals of medical tests performed on the given subject to set the period to be displayed to edit the graph, is required.

Further, in the first embodiment, the test interval obtaining unit 31 obtains past test intervals between past test dates of each of the plurality of medical tests performed on a plurality of subj ects of the past, calculates a frequency distribution of the past test intervals of each medical test based on the obtained past test intervals of the medical test, and determines and obtains the test interval of each medical test based on the calculated frequency distribution. Therefore, the test interval of each medical test can be accurately obtained. As a result, a time series graph preferably showing transitions of the test results of the plurality of medical tests can be generated.

Further, in the first embodiment, the test interval obtaining unit 31 determines the test interval of each medical test based only on test results of a plurality of subjects of the past who have the same disease as that of the patient to be diagnosed (the subject of the given medical tests). Since test intervals of the same medical test may vary depending on the disease, it is highly likely that the test interval of each medical test obtained in the above-described manner is nearer to the test interval of the medical test performed on the given patient to be diagnosed. It should be noted that the present invention is not limited to the above-described embodiment, and the test interval obtaining unit 31 may not obtain the test interval of each medical test for each disease, as long as it obtains the test interval of each medical test based on test results of a plurality of subjects of the past.

In this case, diseases classified in the same class may be handled as one disease. Even when there is scant medical information about each disease, the test intervals can be preferably obtained by effectively using the medical information of the other diseases of the same class. Further, if test intervals are obtained for each of various disease names, the burden of collecting the test intervals is increased. However, by handling diseases classified in the same class as one disease, the increase of the burden of collecting test intervals for corresponding diseases can be reduced. It should be noted that “diseases classified in the same class” herein may refer to diseases classified according to the cause, symptoms, etc., and the diseases may further be classified according to the degree of severity of each disease.

Further, the test interval obtaining unit 31 may obtain only past test intervals between past test dates of each of the plurality of medical tests performed on a plurality of subjects of the past during their periods of hospital visits, and then calculate the frequency distribution of the past test intervals based on the obtained past test intervals and obtain the test interval of each medical test during the periods of hospital visits based on the calculated frequency distribution. In this case, the period to be displayed determining unit 32 determines the longest test interval of the past test intervals of the plurality of medical tests performed during the periods of hospital visits to use it as a period to be displayed for hospital visit period. Then, the graph generation unit 23 can generate a graph showing test results of the given subject during the period of hospital visits of the subject. This is because that, during a hospitalization period, various medical tests may be performed in a concentrated manner and the frequency of each medical test may differ from that during a period of hospital visits. In the case where the given subject is regularly visiting the hospital, a more appropriate period to be displayed for generating a graph can be determined for test intervals of the given subject by calculating the period to be displayed based only on past test intervals of a plurality of subjects of the past during their periods of hospital visits.

Similarly, the test interval obtaining unit 31 may obtain only past test intervals between past test dates of each of the plurality of medical tests performed on a plurality of subjects of the past during their hospitalization periods, and then calculate the frequency distribution of the past test intervals based on the obtained past test intervals and obtain the test interval of each medical test during the hospitalization periods based on the calculated frequency distribution. In this case, the period to be displayed determining unit 32 determines the longest test interval of the past test intervals of the plurality of medical tests performed during the hospitalization periods to use it as a period to be displayed for hospitalization period. Then, the graph generation unit 23 can generate a graph showing test results of the given subject during the hospitalization period of the subject. In the case where the given subject is hospitalized, a more appropriate period to be displayed for generating a graph can be determined for test intervals of the given subject by calculating the period to be displayed based only on past test intervals of a plurality of subjects of the past during their hospitalization periods.

As a second embodiment, the test interval obtaining unit 31 may obtain an upper limit of the period to be displayed on the graph, obtain, for each of the plurality of medical tests performed on the given subject, a predetermined number of test interval (s) immediately before the upper limit of the period to be displayed on the graph, and obtain the obtained predetermined number of test interval (s) to use it (them) as the test interval (s) of the medical test. It should be noted that operations in the second embodiment, except the test interval obtaining process, are almost the same as those in the first embodiment and functions of the functional blocks are also the same. In the following description, differences from the first embodiment are mainly explained, and the explanation of the same features as those of the first embodiment is omitted.

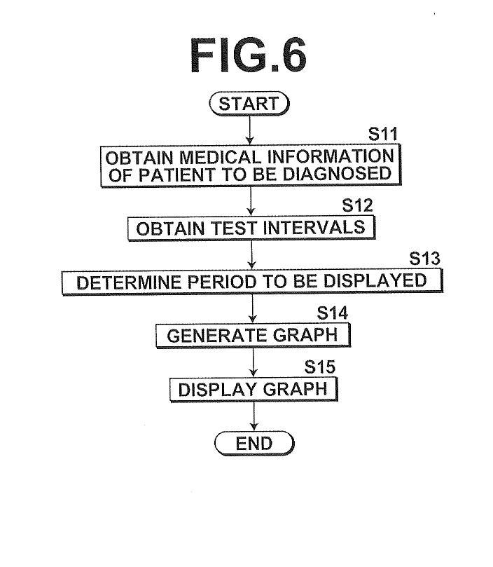

FIG. 6 illustrates the flow of operations performed by the graph generation device 1 in the second embodiment. In the following description, the same operations as those of the above-described embodiment are not explained again.

As shown in FIG. 6, the medical information obtaining unit 22 obtains the patient ID of the patient to be diagnosed, the medical information corresponding to the patient ID and the disease name of the patient, in the same mariner as in S03 shown in FIG. 2 (S11). Further, the medical information obtaining unit 22 receives an input of an upper limit of the period to be displayed by the user to obtain the upper limit of the period to be displayed.

Subsequently, the test interval obtaining unit 31 obtains the patient ID of the patient to be diagnosed, the disease name and the upper limit of the period to be displayed from the medical information obtaining unit 22, and obtains the medical information corresponding to the patient ID of the patient to be diagnosed and the graph generation information corresponding to the disease name from the medical information management server 3. Then, based on the obtained graph generation information, the test interval obtaining unit 31 extracts, from the medical information of the patient to be diagnosed, test results of the given medical tests set in the graph generation information.

Then, the test interval obtaining unit 31 detects, for each medical test Ti included in the given medical tests (1<i≦n, where n is the number medical tests included in the given medical tests), past two test dates immediately before the last day of the period to be displayed, and obtains the interval between the two test dates to use it as a test interval Pi immediately before the upper limit of the period to be displayed. In this manner, the test interval obtaining unit 31 obtains the test interval Pi for each of the n medical tests Ti (1<i≦n).

Now, using the example shown in Table 4, a specific method for calculating the test interval Pi is described with respect to white blood cell count, red blood cell count, hemoglobin concentration and CEA serving as a tumor marker. Table 4 shows an example where a test date A of the past that is the nearest to the upper limit of the period to be displayed and a test date B of the past that is the second nearest to the upper limit of the period to be displayed are detected for each of the medical tests of white blood cell count, red blood cell count, hemoglobin concentration and CEA serving as a tumor marker extracted from the medical information of the patient to be diagnosed, and a test interval between the two test dates of each medical test is calculated.

TABLE 4

| Medical test | Test date A | Test date B | Test interval |
|---|---|---|---|
| White blood cell count | 2012/8/25 | 2012/7/23 | 34 days |
| Red blood cell count | 2012/8/25 | 2012/7/23 | 34 days |
| Hemoglobin | 2012/8/25 | 2012/7/23 | 34 days |
| concentration | | | |
| CEA (tumor maker) | 2012/8/25 | 2012/6/20 | 67 days |

Then, the period to be displayed determining unit 32 determines, based on the test intervals respectively corresponding to the plurality of medical tests obtained by the test interval obtaining unit 31, the period to be displayed on the time series graph such that the period to be displayed is not shorter than the longest test interval of the test intervals (S13) in the above-described example shown in Table 3, the test intervals of the medical tests of white blood cell count, red blood cell count and hemoglobin concentration are 34 days, and the test interval of the medical tests of CEA is 67 days, and therefore the longest test interval Pmax is determined to be 67 days.

Then, similarly to the first embodiment, the period to be displayed determining unit 32 determines, based on the determined test interval Pmax, the period to be displayed to be three months corresponding to the longest test interval Pmax according to Table 3. Then, the period to be displayed determining unit 32 sets the thus determined period to be displayed as the period to be displayed of the obtained graph generation information.

Subsequently, the graph generation unit 23 obtains the graph generation information with the period to be displayed set therein from the medical information management server 3, and extracts, based on the obtained graph generation information, the test results of the given medical tests set in the graph generation information from the obtained medical information of the patient to be diagnosed. Then, the graph generation unit 23 generates a graph showing the extracted test results of the given medical tests according to the obtained graph generation information (S14).

Then, the display control unit 24 instructs to display the time series graph generated by the graph generation unit 23 on the display unit 25 in the same manner as in S05 shown in FIG. 2, and the process ends (S15).

In the above-described second embodiment, similarly to the first embodiment, test intervals of a plurality of medical tests are obtained, and the period to be displayed is determined such that the period to be displayed is not shorter than the longest test interval of the obtained test intervals. Therefore, the generated time series graph contains at least two test results of each medical test. Thus, a graph showing transitions of the test results of the plurality of medical tests can be easily and appropriately generated. Further, no extra work by the user, such as searching for test intervals of given medical tests performed on the subject to set the period to be displayed to edit the graph, is required.

Further, in the above-described second embodiment, the period to be displayed is determined based on test results of the given subject. This allows reliably generating a time series graph showing at least two test results of each of the plurality of medical tests and preferably displaying transitions of the test results. Further, since the period to be displayed can be set based only on the medical information of the given subject, the labor and computational load for collecting the information can be reduced when compared to the case where the test intervals are obtained based on medical tests performed on a plurality of patients of the past.

In the second embodiment, the test interval obtaining unit may obtain an upper limit of the period to be displayed on the graph, obtain two or more test intervals of each of the plurality of medical tests performed on the given subject immediately before the upper limit of the period to be displayed on the graph, and obtain the obtained two or more test intervals to use them as the test intervals of each medical test. In this case, the period to be displayed is determined based on the two or more test intervals, and therefore a graph preferably showing transitions of a plurality of test results can be generated.

In the second embodiment, the diagnosis and treatment department terminal 2, in place of the medical information management server 3, may include the test interval obtaining unit 31 and the period to be displayed determining unit 32.

According to the above-described embodiments, only given medical tests that are regarded important for treatment or diagnosis are set depending on the disease as medical tests to be displayed on the graph in the graph generation information that is stored in advance. Therefore, in the above-described embodiments, the graph generation unit 23 can generate a time series graph based only on the given types of test results that are selected depending on the disease of the given subject from test results of a plurality of medical tests. This reduces unnecessary test results displayed on the display unit, and the doctor, or the like, can easily and efficiently understand only transitions of the test results of the medical tests that are important for the diagnosis or treatment of the disease of the given subject.

In the above-described embodiments, the graph generation unit 23 may show, on the graph, a moving average of test results for each given period if the test results have short test intervals relative to the period to be displayed. For example, in a case where the period to be displayed is six months and the test interval of a certain medical test is a short interval, such as three days, a moving average of the test results for each month may be shown on the graph instead of displaying all the test results on the graph. By calculating and displaying a moving average of test results for each appropriate period on the graph for a medical test having short test intervals relative to the period to be displayed, a situation where too many test results are displayed on a graph to see the graph can be prevented while allowing the user to understand transitions of the test results.

In the above-described embodiments, the period to be displayed is set to be an appropriate period in increments of week, month, or the like, that is longer than the longest test interval Pmax, and this allows the user to more easily understand the period displayed on the graph. It should be noted that the present invention is not limited to the above-described embodiments, and the period to be displayed determining unit 32 may determine the period to be displayed in any manner as long as the period to be displayed is not shorter than the longest test interval Pmax. For example, the longest test interval Pmax may be used as the period to be displayed.

In the above-described embodiments, the graph generation unit 23 may use an adjusted period to be displayed, which is set by adjusting the period to be displayed set in the graph generation information, to generate a time series graph. For example, the graph generation unit 23 may obtain past test dates of each of the given medical tests performed on the patient to be diagnosed on and before the upper limit of the period to be displayed in time series order, and if the most recent test date of the obtained test dates is before the date of the upper limit of the period to be displayed, the graph generation unit 23 may calculate an adjusted period to be displayed by adding, to the period to be displayed set in the graph generation information, the number of days from the most recent date to the date of the upper limit of the period to be displayed to generate a time series graph based on the adjusted period to be displayed.

Further, although a plurality of medical tests that are selected depending on the disease are set in the graph generation information in the above-described embodiments, the plurality medical tests set in the graph generation information may be selected depending on the cause of the disease of the patient, in place of the disease. In this case, the test interval obtaining unit 31 and the period to be displayed determining unit 32 may perform the test interval obtaining process and the period to be displayed determining process as shown in S01-S02 for each cause of the disease (problem), and the graph generation unit 23 may perform the graph generation process as shown in S04 depending on the cause of the disease of the patient to be diagnosed.

It should be noted that the present invention is not limited to the above-described embodiments, and part or all of the components of the graph generation device may be implemented by one workstation, or one or more workstations, servers and/or storage devices connected via a network. Each device is controlled by a program for carrying out the graph generation disclosed herein, which is installed from a recording medium, such as a CD-ROM. Alternatively, the program may be downloaded from a storage device of a server connected via a network, such as the Internet, before being installed.

The above-described embodiments only show some aspects of the present invention, and any variations and modifications may be made to the invention without departing from the spirit and scope of the invention.

What is claimed is:

1. A graph generation device comprising:
a test interval obtaining unit that obtains a plurality of test intervals respectively corresponding to a plurality of medical tests for diagnosis or treatment;
a period to be displayed determining unit that determines a period to be displayed on a time series graph showing test results of the medical tests, wherein the period to be displayed is not shorter than the longest test interval of the obtained test intervals; and
a graph generation unit that generates the time series graph based on the determined period to be displayed and test results of the medical tests performed on a given subject.

2. The graph generation device as claimed in claim 1, wherein the test interval obtaining unit obtains, for each of the medical tests, past test intervals between past test dates of the medical test performed on a plurality of subjects of the past, calculates a frequency distribution of the past test intervals of the medical test based on the obtained past test intervals of the medical test, and determines and obtains the test interval of the medical test based on the calculated frequency distribution.

3. The graph generation device as claimed in claim 2, wherein the test interval obtaining unit calculates a cumulative frequency corresponding to each past test interval based on the frequency distribution, and determines and obtains the past test interval corresponding to the calculated cumulative frequency that reaches or exceeds a predetermined threshold value to use it as the test interval of the medical test.

4. The graph generation device as claimed in claim 2, wherein the test interval obtaining unit obtains, for each of the medical tests, only past test intervals of the medical test performed on the plurality of subjects of the past during their periods of hospital visits, and
the graph generation unit generates the time series graph showing the test results of the given subject during a period of hospital visits of the given subject.

5. The graph generation device as claimed in claim 2, wherein the display interval determining unit determines the longest test interval within a predetermined upper limit.

6. The graph generation device as claimed in claim 2, wherein the plurality of subjects of the past have the same disease as that of the given subject.

7. The graph generation device as claimed in claim 1, wherein the test interval obtaining unit obtains an upper limit of the period to be displayed on the time series graph, obtains, for each of the medical tests performed on the given subject, a predetermined number of test intervals immediately before the upper limit of the period to be displayed on the time series graph, and obtains the obtained predetermined number of test intervals to use them as the test interval of the medical test.

8. The graph generation device as claimed in claim 1, wherein the graph generation unit generates the time series graph based only on given types of test results selected from test results of the medical tests depending on a disease of the given subject.

9. A graph generation method for use with a graph generation device, the method comprising:
a test interval obtaining step of obtaining a plurality of test intervals respectively corresponding to a plurality of medical tests for diagnosis or treatment;
a period to be displayed determining step of determining a period to be displayed on a time series graph showing test results of the medical tests, wherein the period to be displayed is not shorter than the longest test interval of the obtained test intervals; and
a graph generation step of generating the time series graph based on the determined period to be displayed and test results of the medical tests performed on a given subject.

10. A non-transitory recording medium containing a clinical information display program for causing a computer to execute:
a test interval obtaining step of obtaining a plurality of test intervals respectively corresponding to a plurality of medical tests for diagnosis or treatment;
a period to be displayed determining step of determining a period to be displayed on a time series graph showing test results of the medical tests, wherein the period to be displayed is not shorter than the longest test interval of the obtained test intervals; and
a graph generation step of generating the time series graph based on the determined period to be displayed and test results of the medical tests performed on a given subject.
